(19) United States
(12) Patent Application Publication
(10) Pub. No.: US 2026/0235252 A1
(43) Pub. Date: Aug. 13, 2026

(54) MAGNETIC CONNECTING ATTACHMENT FOR ELECTRONIC DEVICE

(71) Applicants: EVOLUTIVE LABS CO., LTD., Taipei City (TW); RHINOSHIELD PTE. LTD., Singapore (SG)

(72) Inventors: CHING CHEN, Taichung City (TW); SHENG-CHE SU, Taichung City (TW); JUI-CHEN LU, Taichung City (TW); CHENG-CHE HO, Taichung City (TW); CHE-WEI HSU, Taichung City (TW)

(73) Assignees: EVOLUTIVE LABS CO., LTD., Taipei City (TW); RHINOSHIELD PTE. LTD., Singapore (SG)

(21) Appl. No.: 19/128,163

(22) PCT Filed: Nov. 7, 2023
(86) PCT No.: PCT/SG2023/050738

§ 371 Date: May 7, 2025

Related U.S. Application Data
(63) Continuation of application No. 18/331,962, filed on Jun. 9, 2023, now abandoned.
(60) Provisional application No. 63/423,067, filed on Nov. 7, 2022.
(60) Provisional application No. 63/458,171, filed on Apr. 10, 2023.
(60) Provisional application No. 63/458,172, filed on Apr. 10, 2023.
(60) Provisional application No. 63/582,840, filed on Sep. 14, 2023.

(30) Foreign Application Priority Data
Jan. 18, 2023 (TW) 112102450
Nov. 6, 2023 (TW) 112142690

(51) Int. Cl. F16M 11/04; A45F 5/00; B65D 23/12; B65D 43/02; F16B 2/04; F16M 11/10; F16M 13/02; H02J 50/10; H04M 1/04

(52) U.S. Cl. CPC F16M 11/041; B65D 23/12; B65D 43/0202; F16B 2/04; F16M 11/10; F16M 13/022; H02J 50/10; H04M 1/04; A45F 5/1516; B65D 2313/04; B65D 2543/00092

(57) ABSTRACT

A magnetic connecting attachment for an electronic device is provided, adapted for an electronic device and a fixing target. The magnetic connecting attachment for an electronic device includes a magnetic attraction member, a sleeving member and a fixing base. The magnetic attraction member is selectively magnetically connected to the electronic device. The sleeving member is detachably sleeving on the fixing target and adapted to be tightened and attached on a surface of the fixing target. The fixing base is disposed on the sleeving member and connected to the magnetic connecting attachment. The magnetic connecting attachment is adapted to be fixed at a first position or a second position relative to the fixing base.

### CROSS-REFERENCE TO RELATED APPLICATION

This application is the U.S. national phase of international application No. PCT/SG 2023/050738 filed on Nov. 7, 2023, which claims priority to US provisional patent application Nos. 63/423,067, 63/458,171, 63/458,172, Ser. No. 18/331,962, and 63/582,840,respectively filed on Nov. 7, 2022, Apr. 10, 2023, Jun. 9, 2023, Sep. 14, 2023, and claims priority to patent application Nos. 112102450 and 112142690 respectively filed in Taiwan, R.O.C. on Jan. 18, 2023 and Nov. 6, 2023. The contents of the above applications are incorporated herein by reference in their entirety.

### BACKGROUND OF THE INVENTION

### 1. Field of the Invention

The present disclosure provides a magnetic connecting attachment for an electronic device, and in particular to a magnetic connecting attachment for an electronic device that can magnetically connect an electronic device and fix the electronic device to a fixing target in a sleeving manner.

### 2. Description of the Related Art

Portable electronic devices are one of the indispensable daily necessities for people in today's society, such as a smartphone, a tablet, a smartwatch, and an e-book reader, all of which bring great convenience to people's lives and work. Taking fitness exercise as an example, when recording videos of their own action details with their smart phones, a user needs to free up his/her both hands and therefore is unable to operate his/her phone simultaneously. Therefore, if there is a product that can temporarily fix the portable electronic device to walls, equipment, or some items, allowing the user to free up his/her both hands, extremely high convenience can be brought.

### BRIEF SUMMARY OF THE INVENTION

However, when a target to be fixed is a non-magnetically sensitive material, a magnetic connecting attachment that attracts the electronic device and the target simply by a magnetic force will not work. Although an adhesive-type attachment can be applied to non-magnetically sensitive fixing targets, the adhesion of the attachment will weaken after multiple uses, and when the target to be fixed has an arc-shaped or curved contour, the adhesive-type attachment in a fixed shape will not be able to adapt to the shape changes of the target, thereby leading to a risk of falling off. In addition, electronic device attachments currently available on the market can only fix the electronic device in a single position. When a user needs to adjust the position of the electronic device based on different needs, the above-mentioned attachments cannot meet the needs of the user.

The inventor thus devoted their ingenuity to meticulous research and development, ultimately creating a magnetic connecting attachment for an electronic device that can magnetically connect an electronic device and fix the electronic device to a fixing target in a sleeving manner, thus achieving the dual purposes of user convenience and stable adhesion to different fixing targets.

A magnetic connecting attachment for an electronic device is provided, adapted for an electronic device and a fixing target. The magnetic connecting attachment for an electronic device includes a magnetic attraction member, a sleeving member and a fixing base. The magnetic attraction member is selectively magnetically connected to the electronic device. The sleeving member is detachably sleeved on the fixing target and adapted to be tightened and attached on a surface of the fixing target. The fixing base is disposed on the sleeving member and connected to the magnetic attraction member. The magnetic attraction member is adapted to be fixed at a first position or a second position relative to the fixing base.

In an embodiment, the above-mentioned sleeving member includes a ring portion and an end portion, where the ring portion defines a fixing channel, and the fixing target is adapted to penetrate through the fixing channel; and the end portion is connected to the ring portion. In addition, the fixing base is formed with a through hole, the end portion penetrates through the through hole, and the fixing base is adapted to move relative to the end portion to change a size of the fixing channel.

In an embodiment, the above-mentioned fixing base includes a main body, an adjusting member, a clamping member and an elastic member. The above-mentioned through hole is formed in the main body; the adjusting member is disposed on the main body and protrudes relative to the main body; the clamping member is disposed on the main body and selectively protrudes towards an interior of the through hole; and the elastic member is disposed between the adjusting member and the clamping member.

In an embodiment, the above-mentioned magnetic attraction member is connected to the end portion, and the magnetic attraction member and the ring portion are disposed on two different sides of the fixing base.

In an embodiment, the above-mentioned electronic device includes a magnetic feature, and the magnetic attraction member includes a magnetic attraction portion and an adjusting portion, a shape of the magnetic attraction portion corresponding to at least a part of the magnetic feature and being adapted to be magnetically connected to the magnetic feature, and the adjusting portion being connected between the magnetic attraction portion and the fixing base and having flexibility.

In an embodiment, the above-mentioned magnetic attraction portion is of an arc-shaped structure, and a central angle included in the arc-shaped structure ranges from 60 degrees to 120 degrees.

In an embodiment, the magnetic connecting attachment for an electronic device includes an engaging member, and the engaging member is pivotally connected to the magnetic attraction member. In addition, the above-mentioned fixing base includes an engaging portion, and the engaging member and the engaging portion are selectively engaged with each other.

In an embodiment, one of the above-mentioned engaging member and the engaging portion is formed with a fitting groove, and the other of the engaging member and the engaging portion is selectively fitted in the fitting groove.

In an embodiment, one of the above-mentioned engaging member and the engaging portion includes a bottom wall, the bottom wall surrounding at least a part of the fitting groove, and the other of the engaging member and the engaging portion includes an abutting surface. When the abutting surface abuts against the bottom wall, the engaging member and the engaging portion are fixed to each other.

In an embodiment, the above-mentioned engaging member is adapted to be engaged with the engaging portion to each other in two different directions of the engaging portion.

In an embodiment, the magnetic connecting attachment for an electronic device further includes a magnetic attraction positioning member, where the magnetic attraction positioning member is disposed between the magnetic attraction member and the engaging member and selectively fixes the magnetic attraction member relative to the engaging member.

In an embodiment, the magnetic connecting attachment for an electronic device further includes a lifting member, where the lifting member is connected to the engaging member, and the lifting member and the engaging member together surround the engaging portion.

In an embodiment, the above-mentioned fixing base further includes two side walls, where the two side walls protrude relative to the sleeving member, and the engaging portion is disposed between the two side walls.

In an embodiment, the above-mentioned magnetic attraction member is pivotally connected to the fixing base.

In an embodiment, the magnetic connecting attachment for an electronic device further includes a pivoting member, where the pivoting member is disposed between the magnetic attraction member and the fixing base, one of the magnetic attraction member and the fixing base is formed with a slide groove, and the pivoting member is slidably arranged in the slide groove.

In an embodiment, the above-mentioned slide groove extends in a lifting direction, and one of the magnetic attraction member and the fixing base has a first groove wall and a second groove wall. The first groove wall and the second groove wall surround at least a part of the slide groove and are disposed on two opposite sides of the slide groove in the lifting direction; the pivoting member selectively abuts against the first groove wall or the second groove wall, and a friction coefficient between the first groove wall and the pivoting member is different from that between the second groove wall and the pivoting member.

In an embodiment, the magnetic connecting attachment for an electronic device further includes a pivoting member, where the fixing base includes a stopping portion, the magnetic attraction member pivots relative to the fixing base through the pivoting member and includes a cam surface, and the cam surface and the stopping portion abut against each other.

In an embodiment, the magnetic connecting attachment for an electronic device further includes a pivoting member and a lifting member, where the pivoting member is disposed on one end of the magnetic attraction member and penetrates through or is pivoted to the fixing base; and the lifting member is connected between the other end of the magnetic attraction member and the fixing base.

In an embodiment, the above-mentioned fixing base is formed with a latching groove, and the lifting member includes a connecting portion and a latching portion. The connecting portion penetrates through the latching groove and has flexibility, and one end of the connecting portion is disposed on the magnetic attraction member; and the latching portion is disposed on the other end of the connecting portion, and a dimension of the latching portion is greater than that of the latching groove.

In an embodiment, the above-mentioned fixing base is pivoted to the sleeving member.

In an embodiment, the magnetic connecting attachment for an electronic device further includes a fixing base positioning member, where the fixing base positioning member is disposed between the fixing base and the sleeving member and selectively fixes the fixing base relative to the sleeving member.

In an embodiment, the above-mentioned magnetic attraction member includes a base portion and a cam portion, where the base portion is adapted to support the electronic device; and the cam portion is connected to the base portion and includes at least one cam surface and an abutting surface. In addition, the above-mentioned fixing base includes an abutting wall, and the cam portion abuts against the abutting wall.

In an embodiment, a number of the above-mentioned cam surfaces is two, and the abutting surface is disposed between the cam surfaces.

In an embodiment, the magnetic connecting attachment for an electronic device further includes a friction fastener, where the friction fastener is detachably disposed on the abutting wall and abuts against the cam portion.

In an embodiment, the above-mentioned fixing base includes a main body and an engaging portion, the engaging portion being movably adapted to protrude from the main body and abutting against the magnetic attraction member.

In an embodiment, an engaging slot is formed in the above-mentioned magnetic attraction member, and the engaging slot is adapted to abut against the engaging portion.

In an embodiment, the magnetic connecting attachment for an electronic device further includes a lifting member, where two ends of the lifting member are connected to the fixing base to form a lifting channel, and the magnetic attraction member is disposed on the lifting member.

In an embodiment, the above-mentioned magnetic attraction member is buried in the lifting member.

In an embodiment, the above-mentioned sleeving member includes a belt body and an adhesive-fastening feature, where the belt body is adapted to define a fixing channel, the adhesive-fastening feature is disposed on one part of the belt body, and the other part of the belt body is adapted to be adhesive-fastened at different positions of the adhesive-fastening feature to adjust a size of the fixing channel.

In an embodiment, a non-slip feature is formed on the surface of the above-mentioned sleeving member, which is adapted to be sleeved onto the fixing target.

In this way, the magnetic connecting attachment for an electronic device can fix an electronic device by magnetic attraction at a first position or a second position through the magnetic attraction member, and be tightened and attached to the surface of a fixing target through the sleeving member, so that the problem that the electronic device cannot be magnetically connected to some targets can be solved, and at the same time, the electronic device can be firmly attached to different fixing targets.

In order to make the above-mentioned features and advantages of the present disclosure more obvious and easier to understand, an embodiment is given, and in conjunction with the accompanying schema, a detailed explanation is given as follows.

### BRIEF DESCRIPTION OF THE DRAWINGS

FIG. 1 is a three-dimensional schematic diagram showing a synergistic effect between a first embodiment of a magnetic connecting attachment for an electronic device of the present disclosure and a fixing target and an electronic device.

FIG. 2 is a schematic front view of a magnetic connecting attachment for an electronic device in FIG. 1.

FIG. 3 is a schematic left side view of a magnetic connecting attachment for an electronic device in FIG. 1.

FIG. 4 is a schematic left side view of a fixing base in FIG. 2.

FIG. 5 is a three-dimensional schematic diagram showing a synergistic effect between a second embodiment of a magnetic connecting attachment for an electronic device of the present disclosure and a fixing target.

FIG. 6 is a three-dimensional schematic diagram of a magnetic connecting attachment for an electronic device in FIG. 5.

FIG. 7 is a schematic plan view of a sleeving member and a fixing base in FIG. 6.

FIG. 8 is a schematic cross-sectional view of FIG. 7 taken along section A-A.

FIG. 9 is a three-dimensional schematic diagram of some elements of a magnetic connecting attachment for an electronic device in FIG. 6.

FIG. 10 is a three-dimensional schematic diagram of a part of a magnetic attraction member in FIG. 9 presented in a transparent form.

FIG. 11 is a schematic left side view of a magnetic connecting attachment for an electronic device of FIG. 5 in a first mode of use.

FIG. 12 is a schematic cross-sectional view of FIG. 11 taken along section B-B.

FIG. 13 is a schematic left side view of a magnetic connecting attachment for an electronic device of FIG. 5 in a second mode of use.

FIG. 14 is a schematic cross-sectional view of FIG. 13 taken along section C-C.

FIG. 15 is a three-dimensional schematic diagram showing a synergistic effect between a third embodiment of a magnetic connecting attachment for an electronic device of the present disclosure and a fixing target.

FIG. 16 is a three-dimensional schematic diagram of a magnetic connecting attachment for an electronic device of FIG. 15.

FIG. 17 is a schematic left side view of a fixing base and a pivoting member in FIG. 16.

FIG. 18 is a schematic cross-sectional view of FIG. 17 taken along section D-D.

FIG. 19 is a three-dimensional schematic diagram of a magnetic attraction member and a lifting member in FIG. 15.

FIG. 20 is a three-dimensional schematic diagram of a magnetic connecting attachment for an electronic device of FIG. 15 in a first mode of use.

FIG. 21 is a schematic left side view of FIG. 20, with some elements omitted.

FIG. 22 is a three-dimensional schematic diagram of a magnetic connecting attachment for an electronic device of FIG. 15 in a second mode of use.

FIG. 23 is a schematic front view of FIG. 22, with some elements omitted.

FIG. 24 is a schematic left side view showing a synergistic effect between a fourth embodiment of a magnetic connecting attachment for an electronic device of the present disclosure and a fixing target.

FIG. 25 is a schematic cross-sectional view of FIG. 24 taken along section E-E.

FIG. 26 is a three-dimensional schematic diagram showing a synergistic effect between a fifth embodiment of a magnetic connecting attachment for an electronic device of the present disclosure and a fixing target.

FIG. 27 is a schematic left side view of some elements of a magnetic connecting attachment for an electronic device in FIG. 26.

FIG. 28 is a schematic cross-sectional view of FIG. 27 taken along section F-F.

FIG. 29 is a partially enlarged schematic diagram of a magnetic attraction member in FIG. 28.

FIG. 30 is a schematic front view showing that a magnetic attraction member and an abutting wall in FIG. 28 are located at a first use position.

FIG. 31 is a schematic front view showing that a magnetic attraction member and an abutting wall in FIG. 28 are located at a second use position.

FIG. 32 is a three-dimensional schematic diagram showing a synergistic effect between a sixth embodiment of a magnetic connecting attachment for an electronic device of the present disclosure and a fixing target.

FIG. 33 is a schematic left side view of a magnetic connecting attachment for an electronic device in FIG. 32.

FIG. 34 is a schematic cross-sectional view of a magnetic connecting attachment for an electronic device of FIG. 33 taken along section G-G in a first mode of use.

FIG. 35 is an enlarged schematic diagram of a circular region in FIG. 34.

FIG. 36 is a schematic cross-sectional view of a magnetic connecting attachment for an electronic device of FIG. 33 taken along section G-G in a second mode of use.

FIG. 37 is a three-dimensional schematic diagram showing a synergistic effect between a seventh embodiment of a magnetic connecting attachment for an electronic device of the present disclosure and a fixing target.

FIG. 38 is a schematic left side view of a fixing base in FIG. 37 at a first use position.

FIG. 39 is a schematic cross-sectional view of FIG. 38 taken along section H-H.

FIG. 40 is a schematic left side view of a fixing base in FIG. 37 at a second use position.

FIG. 41 is a schematic cross-sectional view of FIG. 40 taken along section I-I.

FIG. 42 is a schematic side cross-sectional view of a magnetic attraction member in FIG. 37.

FIG. 43 is a schematic cross-sectional view of a magnetic attraction member and a fixing base in FIG. 37 in a first mode of use.

FIG. 44 is a schematic cross-sectional view of a magnetic attraction member and a fixing base in FIG. 37 in a second mode of use.

FIG. 45 is a three-dimensional schematic diagram of an eighth embodiment of a magnetic connecting attachment for an electronic device of the present disclosure.

FIG. 46 is a three-dimensional schematic diagram of some elements unfolded in FIG. 45.

FIG. 47 is a schematic side cross-sectional view of FIG. 46.

### DETAILED DESCRIPTION OF THE INVENTION

For the aforementioned and other technical contents, features and effects of the present disclosure, they are clearly presented in the following detailed descriptions of preferred embodiments with reference schematics. It is worth mentioning that the directional terms mentioned in the following embodiments, for example, up, down, left, right, front or back, etc., are only directions with reference to additional schematics. Therefore, the directional terms used are intended for illustration, rather than limiting the present disclosure. In addition, in the following embodiments, the same or similar elements will be labeled with the same or similar reference numerals.

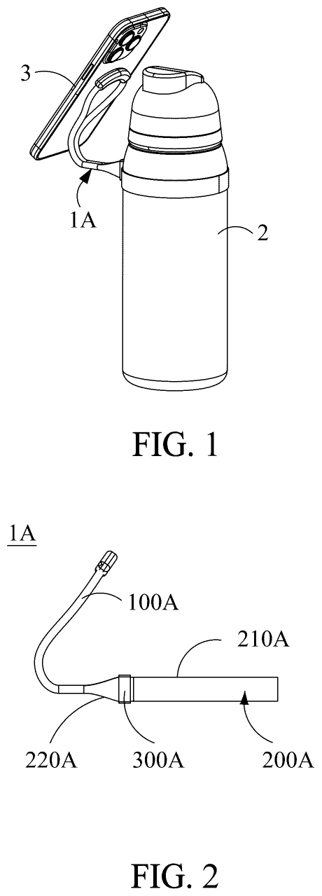

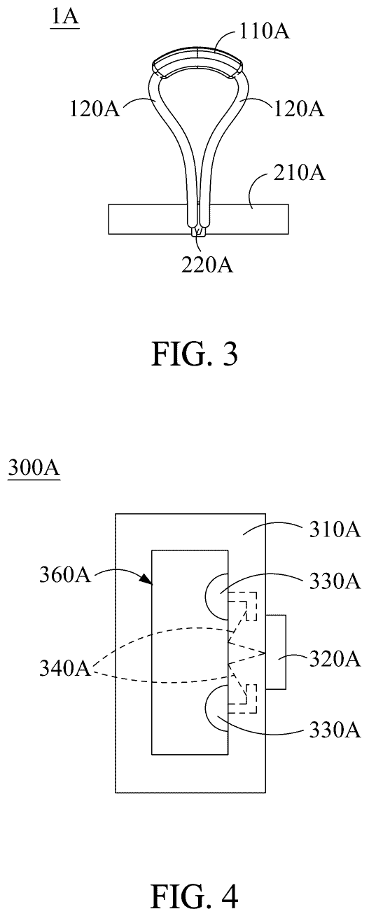

Referring to FIG. 1 to FIG. 3, FIG. 1 is a three-dimensional schematic diagram showing a synergistic effect between a first embodiment of a magnetic connecting attachment for an electronic device of the present disclosure and a fixing target and an electronic device, FIG. 2 is a schematic front view of a magnetic connecting attachment for an electronic device in FIG. 1, and FIG. 3 is a schematic left side view of a magnetic connecting attachment for an electronic device in FIG. 1. The magnetic connecting attachment 1A for an electronic device in this embodiment is adapted to a fixing target 2 and an electronic device 3, where the fixing target 2 is, for example, a kettle, a thermos flask, a handrail, a dumbbell, and even a human head, wrist or ankle and other targets adapted to temporarily fix the electronic device 3, and the electronic device 3 is, for example, a smart phone, a tablet computer, a smart watch or an e-book reader and other portable electronic devices, but the present disclosure does not limit the specific forms of the fixing target 2 and the electronic device 3. In another aspect, the magnetic connecting attachment 1A for an electronic device includes a magnetic attraction member 100A, a sleeving member 200A and a fixing base 300A, where the magnetic attraction member 100A is selectively magnetically connected to the electronic device 3; the sleeving member 200A is detachably sleeved on the fixing target 2 and adapted to be tightened and attached on a surface of the fixing target 2; the fixing base 300A is disposed on the sleeving member 200A and connected to the magnetic attraction member 100A.

In particular, the magnetic attraction member 100A may include a magnetic attraction portion 110A and an adjusting portion 120A. The magnetic attraction portion 110A may include a plastic shell and a permanent magnet, electromagnet or other magnetically sensitive substances buried in the plastic shell, where the plastic shell may be made of hard plastic, and the adjusting portion 120A may be an iron wire wrapped in a soft plastic sheath, and the number of the adjusting portions in this embodiment is, for example, two, and the adjusting portions are disposed at two ends of the magnetic attraction portion 110A. However, in other possible embodiments, the magnetic attraction portion 110A may not be provided with a shell or only be covered with an object such as leather, which is beneficial to lighten the magnetic connecting attachment 1A for an electronic device. In addition to the iron wire, the adjusting portion 120A can also be made of nickel titanium alloy with shape memory ability, thereby maintaining the magnetic attraction member 100A in a fixed shape.

Furthermore, the electronic device 3 may include a magnetic feature, where the magnetic feature is, for example, a magnet array formed in a MAGSAFE interface on a back side of the electronic device 3, and in other embodiments, the magnetic feature may also be a magnetic attraction ring attached to the back side of the electronic device 3 or a back side of a protective case for the electronic device. In another aspect, a shape of the magnetic attraction portion 110A corresponds to at least a part of the magnetic feature. In this embodiment, an arc-shaped structure of the magnetic attraction portion 110A is taken as an example, but the present disclosure is not limited to this. In this way, when the magnetic attraction portion 110A is aligned with a corresponding portion of the magnetic feature of the electronic device 3, the magnetic attraction member 100A can magnetically connect the electronic device 3 through the magnetic attraction portion 110A, so that the electronic device 3 is temporarily fixed onto the magnetic attraction portion 110a.

It is worth mentioning that, as shown in FIG. 3, the magnetic attraction portion 110A of an arc-shaped structure is part of a curvature circle, and a central angle included in the arc-shaped structure is preferably between 60 degrees and 120 degrees. With such a configuration, the magnetically sensitive substance used in the magnetic attraction portion 110A can be appropriately reduced, thus reducing the weight and occupied volume of the magnetic attraction member 100A. Meanwhile, the connection strength of the electronic device 3 magnetically connected to the magnetic attraction member 100A can be ensured, thus avoiding that the electronic device falls off from the magnetic connecting attachment 1A for an electronic device due to an insufficient magnetic attraction force.

In another aspect, the adjusting portion 120A is connected between the magnetic attraction portion 110A and the fixing base 300A, and since the adjusting portion 120A is made of metal wires such as iron wires or nickel-titanium alloy wires, the adjusting portion has both support strength and flexibility. In this way, when a user wants to fix the electronic device 3 through the magnetic attraction member 100A, the adjusting portion 120A can be pressed with fingers to make the adjusting portion deform or change its position relative to the fixing base 300A, thereby switching the magnetic attraction portion 110A between a first position (e.g., an inclined upward position shown in FIG. 1) and a second position (e.g., an inclined downward position), and then the electronic device 3 is magnetically connected to the magnetic attraction portion 110A, thus achieving the effect of fixing the electronic device 3 by magnetic attraction and maintaining the electronic device 3 at different positions relative to the fixing base 300A.

It is worth mentioning that although in this embodiment, the number of the adjusting portions 120A being two and the adjusting portions being disposed on two sides of the magnetic attraction portion 110A is taken as an example, the present disclosure is not limited to this. In other possible embodiments, it is also possible to dispose only one adjusting portion 120A on one side of the magnetic attraction portion 110A and make the adjusting portion present a shape similar to “?”, as long as it can be ensured that the electronic device 3 magnetically connected to the magnetic attraction portion 110A will not fall off due to the weight or the center of gravity of the fixing target 2 will not be influenced. In addition, the above-mentioned inclined upward or inclined downward position is only for illustrative purposes, as long as any position that can be reached by the adjusting portion 120A via deformation or displacement is within the scope of protection of the present disclosure.

Referring to FIG. 1 and FIG. 2 again, the sleeving member 200A in this embodiment is, for example, a silicone annular ring and includes a ring portion 210A and an end portion 220A, where the ring portion 210A surrounds and defines a fixing channel, and the fixing target 2 is adapted to penetrate through the fixing channel; and the end portion 220A is connected to the ring portion 210A. Specifically, when a user wants to fix the electronic device 3 onto the fixing target 2, the fixing target 2 can penetrate through the fixing channel formed by the ring portion 210A, and meanwhile, the position of the ring portion 210A relative to the fixing target 2 can be adjusted. After determining the relative position between the ring portion 210A and the fixing target 2, a user can tighten and attach the sleeving member 200A to the surface of the fixing target 2, for example, to the lid or body of a kettle, and thereby, the electronic device 3 magnetically connected to the magnetic attraction member 100A is fixed onto the fixing target 2, and the own functions of the electronic device 3 can be executed to meet various use needs of the user, such as viewing, video recording, shooting and amusement.

In some possible embodiments, the sleeving member 200A is used for being sleeved on the surface of the fixing target 2, that is, a non-slip feature is formed on an inner side of the ring portion 210A, where the non-slip feature is, for example, rubber, knurls or relatively rough fabric. With such a configuration, after the sleeving member 200A is tightened to the surface of the fixing target 2, the magnetic connecting attachment 1A for an electronic device is less likely to slide up and down relative to the fixing target 2.

It is worth mentioning that when the sleeving member 200A is sleeved on the fixing target 2, the magnetic attraction member 100A can be directly used as a handle, that is, a user can lift the sleeving member 200A through the magnetic attraction member 100A and walk with the attached fixing target 2 carried together, which is simple and convenient to use. In addition, hereafter or in other possible embodiments, a user can also make a lifting member such as a belt, a lanyard, or a metal chain penetrate through the sleeving member 200A or connect the lifting member to the sleeving member 200A, and lift the fixing target 2 and the electronic device 3 through the lifting member through the magnetic connecting attachment 1A for an electronic device while the electronic device 3 is magnetically connected to the magnetic attraction member 100A, thereby improving the convenience of the user to carry the fixing target 2 and the electronic device 3.

Referring to FIG. 2 to FIG. 4 together, FIG. 4 is a schematic left side view of a fixing base in FIG. 2. In particular, the fixing base 300A in this embodiment has the function of changing a size of the fixing channel, thereby tightening the sleeving member 200A onto the surface of the fixing target 2. As shown in FIG. 4, the fixing base 300A may include a main body 310A, an adjusting member 320A, a clamping member 330A, and an elastic member 340A, where the main body 310A presents, for example, a rectangular cylinder and is formed with a through hole 360A; the adjusting member 320A is, for example, a button, which is disposed on the main body 310A and protrudes relative to the main body 310A; the clamping member 330A may be, for example, a half-spherical chuck, and the number of the clamping member in this embodiment is, for example, two, and the clamping members are disposed on the main body 310A and protrude relative to an interior of the through hole 360A; and the elastic member 340A is, for example, an elastic arm, the number of which corresponds to the number of the clamping members 330A, and the elastic members are disposed between the adjusting member 320A and the clamping member 330A. Furthermore, the end portion 220A of the sleeving member 200A can penetrate through the through hole 360A and be connected to the adjusting portion 120A of the magnetic attraction member 100A, that is, the magnetic attraction member 100A and the ring portion 210A of the sleeving member 200A can be disposed on two different sides of the fixing base 300A. When a user wants to tighten the ring portion 210A, the adjusting member 320A can be pressed to make the elastic member 340A deform and drive the clamping member 330A to move towards the outer side of the through hole 360A. At this time, the cross-sectional area of the through hole 360A increases, and therefore, the fixing base 300A can move towards the ring portion 210A in the extending direction of the end portion 220A, thereby changing the size of the fixing channel and tightening the sleeving member 200A to the fixing target 2. After the sleeving member 200A is tightened, the user can stop pressing the adjusting member 320A. At this time, the clamping member 330A will be driven by an elastic force of the elastic member 340A and protrude towards the interior of the through hole 360A again and clamp a part of the end portion 220A, thereby avoiding that the fixing base 300A slides relative to the end portion 220A.

Similarly, when the user wants to remove the sleeving member 200A from the fixing target 2, the fixing base 300A can be moved away from the ring portion 210A relative to the end portion 220A, thereby expanding the fixing channel, so that the sleeving member 200A is removed from the fixing target 2. It is worth mentioning that although in this embodiment, the adjusting portion 120A being directly connected to one end of the end portion 220A is taken as an example, the present disclosure is not limited to this. In other possible embodiments, the adjusting portion 120A can also be directly formed on the fixing base 300A, and the end portion 220A can penetrate through the fixing base 300A through the through hole 360A in the main body 310A, which can also achieve the effect of adjusting the fixing channel.

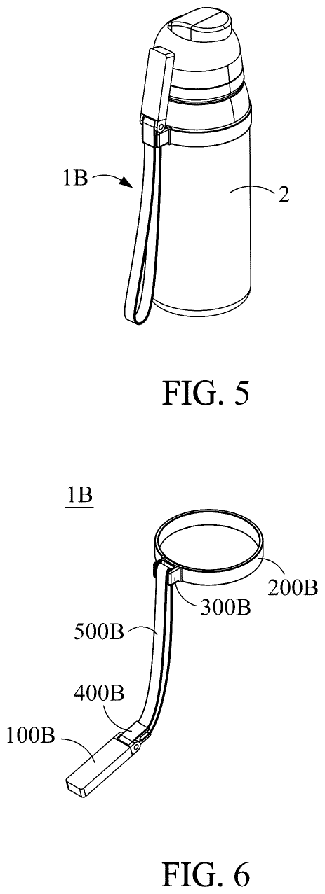

Referring to FIG. 5 and FIG. 6, FIG. 5 is a three-dimensional schematic diagram showing a synergistic effect between a second embodiment of a magnetic connecting attachment for an electronic device of the present disclosure and a fixing target, and FIG. 6 is a three-dimensional schematic diagram of a magnetic connecting attachment for an electronic device in FIG. 5. The magnetic connecting attachment 1B for an electronic device in this embodiment includes a magnetic attraction member 100B, a sleeving member 200B and a fixing base 300B, where the sleeving member 200B is adapted to be sleeved on the fixing target 2, and the fixing base 300B is disposed on the sleeving member 200B and connected to the magnetic attraction member 100B. The main difference from the magnetic connecting attachment 1A for an electronic device in the first embodiment is that the magnetic connecting attachment 1B for an electronic device further includes an engaging member 400B and a lifting member 500B.

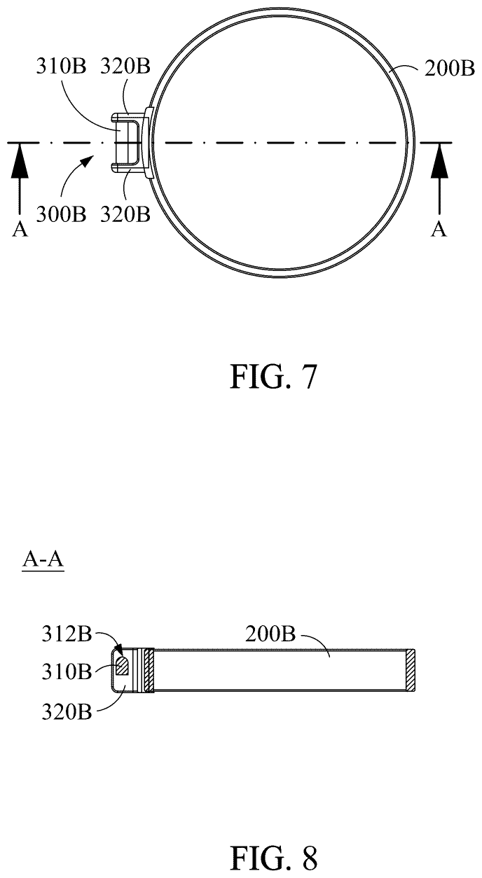

Referring to FIG. 7 and FIG. 8, FIG. 7 is a schematic plan view of a sleeving member and a fixing base in FIG. 6, and FIG. 8 is a schematic cross-sectional view of FIG. 7 taken along section A-A. As shown, the sleeving member 200B in this embodiment is, for example, an elastic latex collar, which can be automatically tightened according to the shape of the fixing target 2, and the fixing base 300B, for example, is fixed on the sleeving member 200B and includes an engaging portion 310B and two side walls 320B. These side walls 320B protrude relative to the sleeving member 200B and are parallel to each other, while the engaging portion 310B, for example, is of an arched columnar structure disposed between these side walls 320B, and the engaging portion 310B is formed with an abutting surface 312B for being engaged with an engaging member 400B.

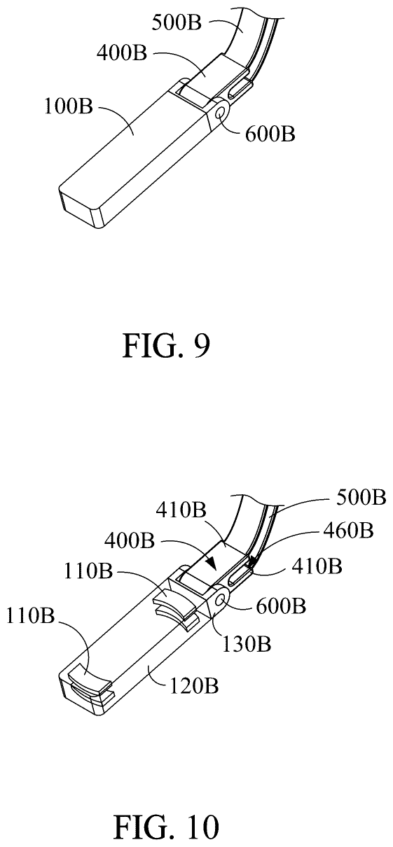

Referring to FIG. 9 and FIG. 10, FIG. 9 is a three-dimensional schematic diagram of some elements of a magnetic connecting attachment for an electronic device in FIG. 6, and FIG. 10 is a three-dimensional schematic diagram of a part of a magnetic attraction member in FIG. 9 presented in a transparent form. In particular, the magnetic attraction member 100B in this embodiment includes a magnetic attraction portion 110B and a base portion 120B, where the magnetic attraction portion 110B is, for example, a permanent magnet or other magnetically sensitive substance, and the number of the magnetic attraction portions in this embodiment is, for example, four, and the four magnetic attraction portions are oppositely disposed in pairs spaced apart, and the shape and the positions where the magnetic attraction portions are disposed correspond to at least a part of the magnetic feature on the electronic device 3. In another aspect, the base portion 120B is of, for example, a rectangular columnar structure formed by injection molding, and a cavity corresponding to the magnetic attraction portion 110B is formed inside. In this way, the magnetic attraction member 100B can magnetically attract the electronic device 3 through the magnetic attraction portion 110B embedded or buried in the base portion 120B, thus achieving the same or similar effect as the magnetic attraction member 100A in the first embodiment.

In addition, the engaging member 400B in this embodiment is pivotally connected to the magnetic attraction member 100B, and the engaging member 400B is used for being engaged with the engaging portion 310B of the fixing base 300B. Specifically, the magnetic connecting attachment 1B for an electronic device in this embodiment may further include a pivoting member 600B, and the magnetic attraction member 100B is formed with lugs 130B protruding relative to the base portion 120B on two sides of one end of the base portion 120B, where the lug 130B and the engaging member 400B are each formed with a through hole for the pivoting member 600B to penetrate through. With such a configuration, the engaging member 400B can be pivoted to the magnetic attraction member 100B through the pivoting member 600B.

It is worth mentioning that in some possible embodiments, the magnetic connecting attachment 1B for an electronic device further includes a magnetic attraction positioning member (not shown), where the magnetic attraction positioning member is, for example, a positioning gear, a bump, or a buckling groove that can fix the pivoting member 600B. In this way, when the engaging member 400B pivots to a specific phase relative to the magnetic attraction member 100B, the magnetic attraction positioning member can be operated so that the magnetic attraction member 100B is fixed relative to the engaging member 400B.

In another aspect, the lifting member 500B is, for example, a loop lanyard and has flexibility, but it may also be other elements suitable for lifting, e.g., a belt, an iron chain or a woven strap, which is not limited by the present disclosure. In particular, the engaging member 400B may include two end portions 410B, and a fitting groove 460B is formed between these end portions 410B. In other words, the engaging member 400B with the end portions 410B appears in a “U: shape when viewed from the side, and two ends of the lifting member 500B are each connected to the end portion 410B of the engaging member 400B, so that the lifting member 500B and the engaging member 400B together surround the engaging portion 310B of the fixing base 300B.

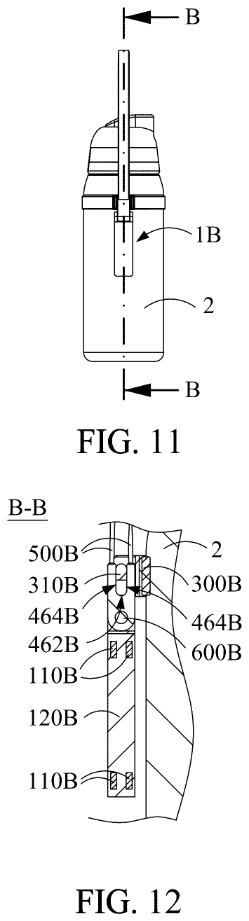

Referring to FIG. 11 and FIG. 12, FIG. 11 is a schematic left side view of a magnetic connecting attachment for an electronic device of FIG. 5 in a first mode of use, and FIG. 12 is a schematic cross-sectional view of FIG. 11 taken along section B-B. When a user wants to directly lift the fixing target 2 through the magnetic connecting attachment 1B for an electronic device, the engaging member 400B can be engaged with the engaging portion 310B from the bottom portion of the engaging portion 310B. At this time, two sides of the engaging portion 310B will abut against two side walls 464B of the fitting groove 460B, so that the engaging member 400B is fixed at a first position relative to the fixing base 300B. In other words, since the sleeving member 200B, the fixing base 300B, the engaging member 400B and the fixing target 2 are all fixed to each other, the user can directly lift the engaging member 400B through the lifting member 500B and lift the fixing target 2 together, thus achieving the effect of easily carrying the fixing target 2.

In some possible embodiments, knurls for increasing friction can be disposed on the two side walls 464B of the fitting groove 460B, so that the engaging portion 310B and the fitting groove 460B are less likely to move relative to each other after being fixed to each other. Alternatively, the fitting groove 460B can be formed into a V-shaped structure wide at the top and narrow at the bottom, so that the deeper the engaging portion 310B enters the fitting groove 460B, the stronger the fitting interference force therebetween, thus further strengthening the fitting relationship therebetween.

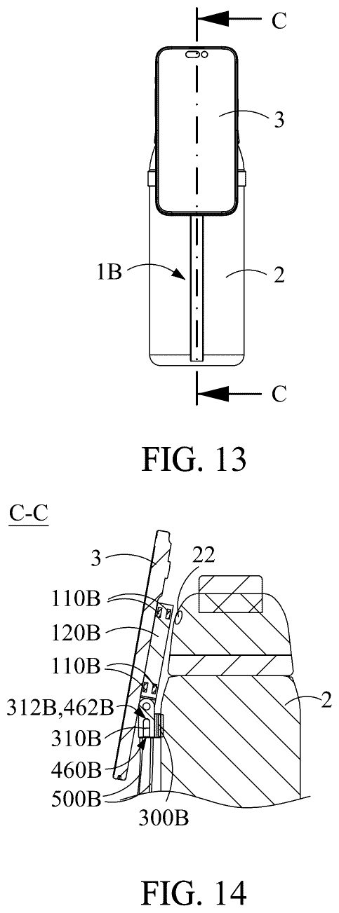

Referring to FIG. 13 and FIG. 14, FIG. 13 is a schematic left side view of a magnetic connecting attachment for an electronic device of FIG. 5 in a second mode of use, and FIG. 14 is a schematic cross-sectional view of FIG. 13 taken along section C-C. When a user wants to fix the electronic device 3 by magnetic attraction onto the fixing target 2 through the magnetic connecting attachment 1B for an electronic device, the engaging member 400B can be engaged with the engaging portion 310 from the upper portion of the engaging portion 310B. At this time, in addition to two sides of the engaging portion 310B abutting against the two side walls 464B of the fitting groove 460B, the engaging portion 310B will gradually enter the deepest part of the fitting groove 460B until the abutting surface 312B of the engaging portion 310B abuts against a bottom wall 462B of the fitting groove 460B, so that the engaging member 400B and the engaging portion 310B are completely fixed to each other. At this time, the user can adjust a pivoting angle of the magnetic attraction member 100B relative to the engaging member 400B, and then magnetically attract the electronic device 3 to the magnetic attraction member 100B, so that the electronic device 3 can be temporarily fixed onto the fixing target 2.

It is worth mentioning that, in addition to fixing the position of the magnetic attraction member 100B relative to the engaging member 400B by using the above-mentioned magnetic attraction positioning member, in some possible embodiments, the fixing target 2 can also be formed with a magnetic feature 22 corresponding to the magnetic attraction portion 110B, where the magnetic feature 22 is, for example, an iron ring surrounding the fixing target 2 in a circumferential direction. With such a configuration, after the engaging member 400B is fixed to the engaging portion 310B, the magnetic attraction member 100B can pivot and abut against the surface of the fixing target 2, and the magnetic attraction member 100B can be stably maintained at a second position through the mutual magnetic attraction action between the magnetic attraction portion 110B and the magnetic feature 22, thus further enhancing the stability of the electronic device 3 during magnetic attraction. Meanwhile, since the engaging member 400B and the lifting member 500B are kept surrounding the engaging portion 310B, the fixing target 2 can be prevented from falling off the magnetic connecting attachment 1B for an electronic device as long as the user holds the lifting member 500B, thereby reducing the risk of damage to the fixing target 2 caused by a collision.

Alternatively, a groove for accommodating at least a part of the magnetic attraction member 100B may be formed in the fixing target 2. In this way, when the magnetic attraction member 100B can be accommodated in the above-mentioned groove while magnetically attracting the electronic device 3, the magnetic attraction member 100B pivoting or moving relative to the fixing target 2 can be avoided.

In addition, although in this embodiment, the upper surface of the engaging portion 310B being formed with an abutting surface 312B, and the engaging member 400B and the engaging portion 310B being engaged with each other in up and down directions of the engaging portion 310B to achieve different uses is taken as an example, the present disclosure is not limited to this. By way of example, in other possible embodiments, the engaging portion 310B can also be formed with an abutting surface 312B corresponding to a bottom wall 462B in the up and down directions, and thereby, the engaging member 400B and the engaging portion 310B can be completely fixed through the abutting of the 312B against the bottom wall 462B, regardless of whether the engaging member 400B and the engaging portion 310B are engaged with each other in the up or down direction.

In addition, although when the first mode of use is explained above, it is illustrated with that a user wants to lift the fixing target 2 through the magnetic connecting attachment 1B for an electronic device, the present disclosure is not limited to this. In other possible embodiments, the magnetic connecting attachment 1B for an electronic device may not be provided with the lifting member 500B, but the magnetic attraction member 100B is temporarily engaged and fixed onto the fixing base 300B simply by the engaging member 400B, so that the magnetic connecting attachment 1B for an electronic device is convenient to carry through the fixing target 2. Furthermore, although in this embodiment, the engaging member 400B and the lifting member 500B together surrounding the engaging portion 310B is taken as an example, in other possible embodiments, the engaging portion 310B may also be a columnar member connected only to one of the side walls 320B, and a gap is formed between the engaging portion 310B and the other side wall 320B. In this way, a user can detach the lifting member 500B from the gap between the engaging portion 310B and the side wall 320B, and detach the magnetic attraction member 100B, the engaging member 400B and the lifting member 500b from the fixing target 2.

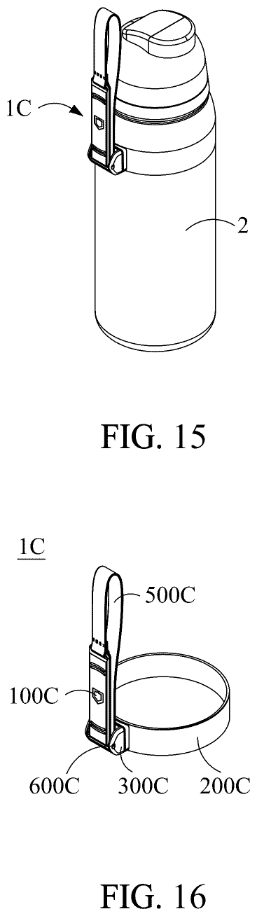

Referring to FIG. 15 and FIG. 16, FIG. 15 is a three-dimensional schematic diagram showing a synergistic effect between a third embodiment of a magnetic connecting attachment for an electronic device of the present disclosure and a fixing target, and FIG. 16 is a three-dimensional schematic diagram of a magnetic connecting attachment for an electronic device of FIG. 15. The magnetic connecting attachment 1C for an electronic device in this embodiment is roughly similar to the magnetic connecting attachment 1B for an electronic device in the second embodiment, and includes a magnetic attraction member 100C, a sleeving member 200C, a fixing base 300C, a lifting member 500C and a pivoting member 600C. The main difference therebetween is that the magnetic connecting attachment 1C for an electronic device does not have an engaging member, and the magnetic attraction member 100C is pivotally connected to the fixing base 300c.

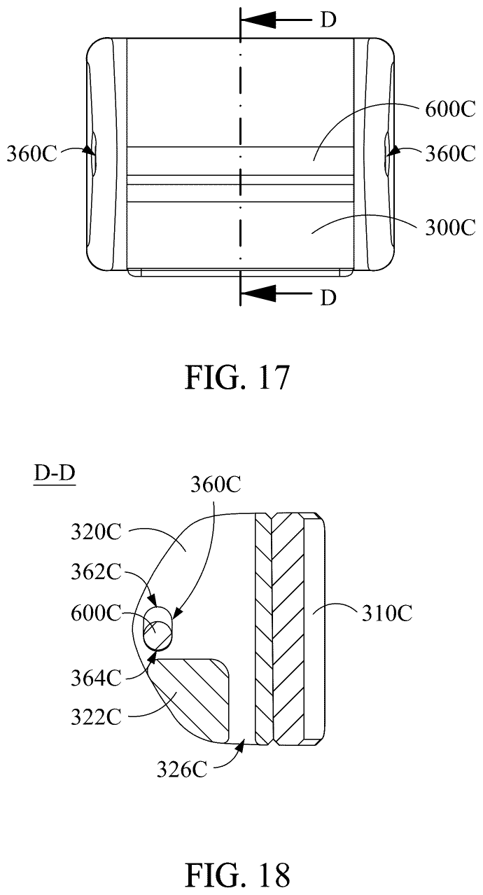

Referring to FIG. 17 and FIG. 18, FIG. 17 is a schematic left side view of a fixing base and a pivoting member in FIG. 16, and FIG. 18 is a schematic cross-sectional view of FIG. 17 taken along section D-D. In particular, the fixing base 300C in this embodiment includes a main body 310C and a pivoting portion 320C, where the main body 310C is fixed relative to the sleeving member 200C, and the pivoting portion 320C is pivoted to the main body 310C and used for pivoting with the magnetic attraction member 100B. Furthermore, the attachment 1C for an electronic device may further include a fixing base positioning member (not shown), where the fixing base positioning member is, for example, a positioning gear and is disposed between the main body 310C and the pivoting portion 320C. With such a configuration, the pivoting portion 320C can pivot relative to the main body 310C and be fixed relative to the main body 310C after pivoting to a specific position, thereby changing the position or orientation of the electronic device 3 relative to the fixing target 2. However, in other possible embodiments, the fixing base positioning member can also be disposed between the fixing base 300C and the sleeving member 200C, that is, the main body 310C is pivoted onto the sleeving member 200C, and the way in which the pivoting portion 320C is fixed relative to the main body 310C implements the pivoting of the fixing base 300C, which is not limited by the present disclosure.

In addition, as shown in FIG. 17 and FIG. 18, a slide groove 360C can be formed in the pivoting portion 320C, and the pivoting member 600C is slidably arranged in the slide groove 360C. Furthermore, the slide groove 360C extends in a lifting direction. In this embodiment, the lifting direction is, for example, the up-down direction in FIG. 18, but the present disclosure is not limited to this. In other embodiments, the slide groove 360C can also extend diagonally or presents an arc shape. In addition, the pivoting portion 320C has a first groove wall 362C and a second groove wall 364C, where the first groove wall 362C and the second groove wall 364C surround at least a part of the slide groove 360C and are disposed on two opposite sides of the slide groove 360C in the lifting direction, respectively. In this embodiment, the first groove wall 362C being used as an upper end hole wall of the slide groove 360C, and the second groove wall 364C being used as a lower end hole wall of the slide groove 360C is taken as an example. In this embodiment, a friction coefficient between the first groove wall 362C and the pivoting member 600C is different from that between the second groove wall 364C and the pivoting member 600C. In this embodiment, the friction coefficient between the first groove wall 362C and the pivoting member 600C being less than the friction coefficient between the second groove wall 364C and the pivoting member 600C is taken as an example. With such a configuration, when the pivoting member 600C abuts against the first groove wall 362C or the second groove wall 364C in the lifting direction, the difficulty for the pivoting member 600C to pivot relative to the fixing base 300C can be adjusted due to different friction coefficients therebetween.

In another aspect, the pivoting portion 320C may further include a stopping portion 322C, which is used for being stopped from each other with the magnetic attraction member 100C, thereby changing the relative position of the magnetic attraction member 100C between different pivoting phases and the fixing base 300C. In some possible embodiments, a latching groove 326C is also formed between the stopping portion 322C and the main body 310C, where the latching groove can be used for being engaged with the lifting member 500C.

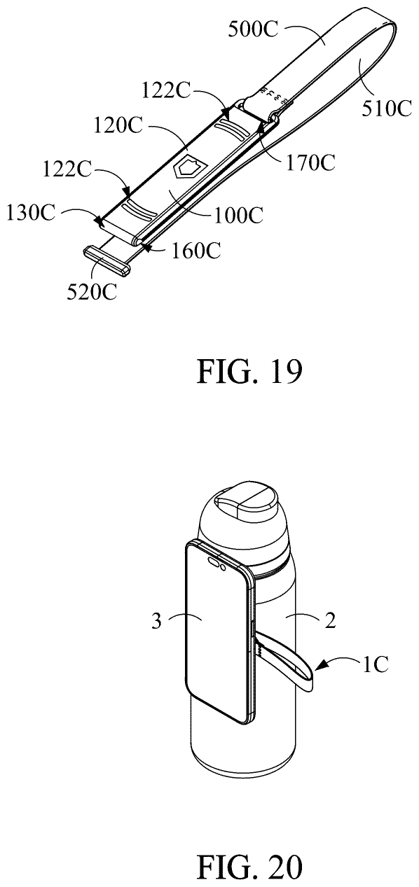

Referring to FIG. 19, FIG. 19 is a three-dimensional schematic diagram of a magnetic attraction member and a lifting member in FIG. 15. The magnetic attraction member 100C in this embodiment is of, for example, a rectangular sheet-like structure, which is similar to that of the magnetic attraction member 100B in the second embodiment. The magnetic attraction member 100C includes a base portion 120C and a magnetic attraction portion (not shown) buried in the base portion 120C. At least one indication feature 122C may be formed on the surface of the base portion 120C, where the indication feature 122C is, for example, an arc-shaped pattern and corresponds to a position where the magnetic attraction portion is buried. In this way, a user can confirm the position of the magnetic attraction portion through the indication feature 122C, so that the electronic device 3 is quickly and correctly aligned with the magnetic attraction member 100C. In addition, the magnetic attraction member 100C can also be formed with a cam surface 130C, where the cam surface 130C is, for example, disposed on one end of the magnetic attraction member 100C, and is used for being stopped from each other with the stopping portion 322C, and the base portion 120C is formed with a pivoting hole 160C in one end where the cam surface 130C is disposed, where the pivoting hole is used for the pivoting member 600C to penetrate through.

In addition, the base portion 120C may be formed with a perforation 170C in one end opposite to the pivoting hole 160C, and the lifting member 500C includes a connecting portion 510C and a latching portion 520C, where the connecting portion 510C has flexibility; one end of the connecting portion penetrates through the perforation 170C, and thereby, the connecting portion and the magnetic attraction member 100C are fixed to each other, and the latching portion 520C is disposed on the other end of the connecting portion 510C, and a dimension of the latching portion 520C is greater than that of the latching groove 326C.

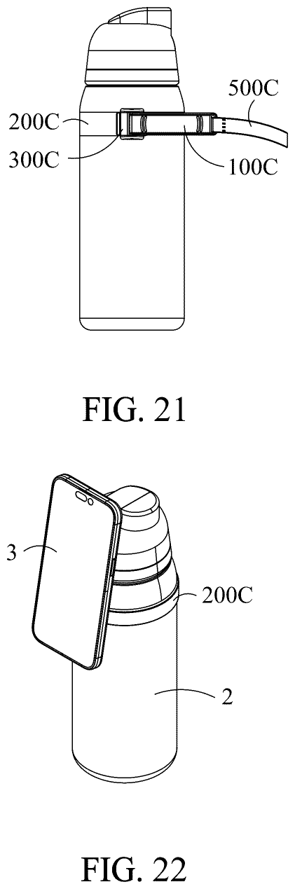

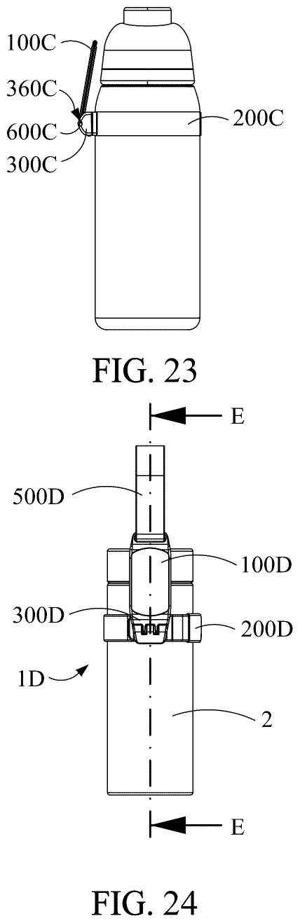

Referring to FIG. 20 to FIG. 23, FIG. 20 is a three-dimensional schematic diagram of a magnetic connecting attachment for an electronic device of FIG. 15 in a first mode of use, FIG. 21 is a schematic left side view of FIG. 20, with some elements omitted, FIG. 22 is a three-dimensional schematic diagram of a magnetic connecting attachment for an electronic device of FIG. 15 in a second mode of use, and FIG. 23 is a schematic front view of FIG. 22, with some elements omitted. The use principle of the magnetic connecting attachment 1C for an electronic device in this embodiment will be described in detail below. Firstly, the configuration relationship of constituent elements of the magnetic connecting attachment 1C for an electronic device will be introduced. The connecting portion 510C penetrates through the latching groove 326C, so that the latching portion 520C can be retained on the lower end of the latching groove 326C by being stopped by the latching groove 326C, while the other end of the connecting portion 510C penetrates through the perforation 170C from the upper portion of the latching groove 326C, and thereby, the connecting portion and the magnetic attraction member 100C are fixed to each other. The pivoting member 600C penetrates through the pivoting hole 160C of the magnetic attraction member 100C and the slide groove 360C of the pivoting portion 320C simultaneously, so that the cam surface 130C and the stopping portion 322C abut against each other.

A user can firstly install the sleeving member 200C and the fixing base 300C disposed on the sleeving member 200C to an appropriate position of the fixing target 2. When the user wants to magnetically connect the electronic device 3, as shown in FIG. 21, the fixing base 300C can be pivoted to a horizontal phase together with the magnetic attraction member 100C, and then the electronic device 3 can be fixed onto the magnetic attraction member 100C by magnetic attraction. In this way, the user not only can change the pivoting phase of the electronic device 3 in the drawing of FIG. 21 through the pivoting of the fixing base 300C, but also can make the magnetic attraction member 100C slightly adjust the relative position of the magnetic attraction member 100C and the fixing base 300C through the sliding of the pivoting member 600C relative to the slide groove 360C, and even can change the inclination angle of the magnetic attraction member 100C through the pivoting of the pivoting member 600C. In other words, the electronic device 3 in this embodiment has three different degrees of freedom of movement, which provides extremely high convenience for both general use and shooting and video recording.

In another aspect, when a user wants to stably fix the electronic device 3 at a specific position or angle, or wants to lift the fixing target 2 through the magnetic connecting attachment 1C for an electronic device, the fixing base 300C can be pivoted to the vertical upward orientation as shown in FIG. 23. When the electronic device 3 is carried on the magnetic attraction member 100C, the magnetic attraction member 100C and the pivoting member 600C embedded in the pivoting hole 160C will slide downwards relative to the fixing base 300C under the weight of the electronic device 3, so that the pivoting member 600C abuts against the second groove wall 364C with higher friction, and the frictional resistance for the pivoting member 600C to pivot relative to the fixing base 300C is increased. In other words, by setting the friction coefficient between the first groove wall 362C and the pivoting member 600C and the friction coefficient between the second groove wall 364C and the pivoting member in the slide groove 360C to be different, the friction between the pivoting member 600C and the fixing base 300C can be automatically adjusted in response to supporting for the electronic device 3, thereby enhancing the magnetic attraction of the electronic device 3 and the stability during use.

It is worth mentioning that although in this embodiment, the magnetic attraction member 100C and the pivoting member 600C synchronously move and rotate, and the slide groove 360C being formed on the fixing base 360C are taken as an example, which is not limited by the present disclosure. In other possible embodiments, the slide groove can also be formed in the magnetic attraction member 100C, and the pivoting member 600C is fixed oppositely to the fixing base 300C (for example, the fixing base 300C and the pivoting member 600C are integrally formed). At this time, the upper groove wall of the slide groove of the magnetic attraction member 100C will be correspondingly configured as a wall surface with a high friction coefficient, while the lower groove wall will be configured as a wall surface with a low friction coefficient. Thus, the same effect can be achieved.

In addition, since one end of the connecting portion 510C penetrates through the through hole 170C, and the latching portion 520C disposed on the other end of the connecting portion 510C will also be engaged with the latching groove 326C when lifting with the lifting member 500C, the connection relationship between the lifting member 500C, the magnetic attraction member 100C and the fixing base 300C can be ensured, thus avoiding that the fixing target 2 accidentally falls off. In other possible embodiments, the magnetic connecting attachment 1C for an electronic device may not have the lifting member 500C, but the electronic device 3 is magnetically connected simply relying on the magnetic attraction member 100C. In this case, the upper end of the magnetic attraction member 100C is not limited by the connecting portion 510C and the latching portion 520C. Therefore, a pivotable angle is larger, thereby providing more diverse magnetic attraction positions.

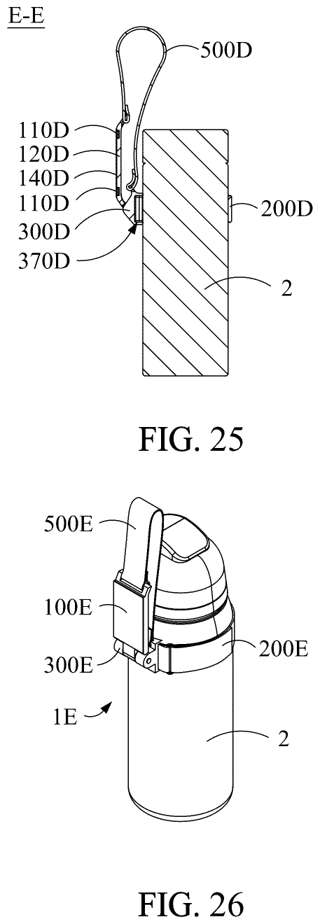

Referring to FIG. 24 and FIG. 25, FIG. 24 is a schematic left side view showing a synergistic effect between a fourth embodiment of a magnetic connecting attachment for an electronic device of the present disclosure and a fixing target, and FIG. 25 is a schematic cross-sectional view of FIG. 24 taken along section E-E. The magnetic connecting attachment 1D for an electronic device in this embodiment is roughly similar to the magnetic connecting attachment 1C for an electronic device in the third embodiment, and includes a magnetic attraction member 100D, a sleeving member 200D, a fixing base 300D and a lifting member 500D. The main difference therebetween is that the sleeving member 200D is of a releasable open structure.

As shown, the sleeving member 200D is, for example, a belt or a woven strap and has two opposite end portions, where one end portion is provided with a plurality of positioning holes, and the other end portion is provided with a positioning member (e.g., a bolt) that can penetrate through one of the positioning holes. In another aspect, a perforation 370D can be formed in the fixing base 300D. With such a configuration, a user can make the sleeving member 200D penetrate through the perforation 370D to fix the fixing base 300D at a specific position on the fixing target 2, and then make the positioning member on one end portion of the sleeving member 200D penetrate through one of the positioning holes, thus achieving the effect of tightening the sleeving member 200D relative to the fixing target 2. However, in other possible embodiments, the sleeving member 200D may not be provided with positioning holes, and the size of the fixing channel may be changed through other fixing structures. By way of example, the sleeving member 200D may include a belt body and an adhesive-fastening feature, where the adhesive-fastening feature is, for example, a hook-and-loop fasteners and is disposed on two different portions of the belt body. After the belt body is tightened relative to the fixing target 2, the adhesive-fastening feature on one of the portions of the belt body can be adhesive-fastened to the adhesive-fastening feature on the other portion of the belt body, and the size of the fixing channel is adjusted by changing the adhesive-fastening position.

In another aspect, the magnetic attraction member 100D in this embodiment can be directly pivoted to the fixing base 300D. Specifically, as shown in FIG. 24, claws that match each other can be formed on the lower end of the magnetic attraction member 100D and the fixing base 300D. With such a configuration, the magnetic attraction member 100D can freely pivot to a specific phase relative to the fixing base 300D, and be fixed by way of positioning gears or bumps, which can also achieve the effect of fixing the electronic device 3 onto the fixing target 2 by magnetic attraction.

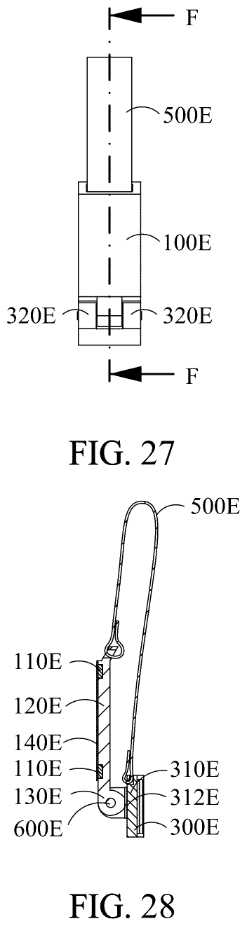

Referring to FIG. 26 and FIG. 27, FIG. 26 is a three-dimensional schematic diagram showing a synergistic effect between a fifth embodiment of a magnetic connecting attachment for an electronic device of the present disclosure and a fixing target, and FIG. 27 is a schematic left side view of some elements of a magnetic connecting attachment for an electronic device in FIG. 26. The magnetic connecting attachment 1E for an electronic device in this embodiment is roughly similar to the magnetic connecting attachment 1D for an electronic device in the fourth embodiment, and includes a magnetic attraction member 100E, a sleeving member 200E, a fixing base 300E, a lifting member 500E and a pivoting member 600E. The main difference therebetween is that the magnetic attraction member 100E selectively forms a close-fitting interference with the fixing base 300E through a cam.

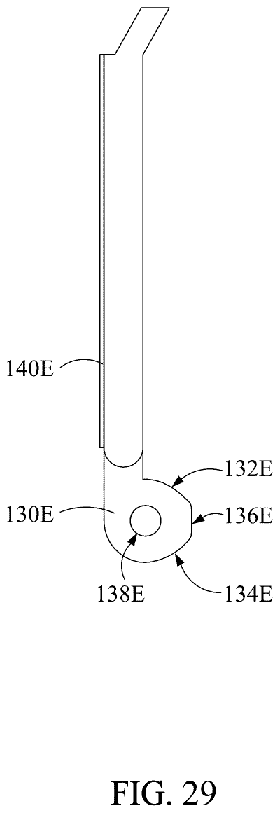

Referring to FIG. 27 to FIG. 29 together, FIG. 28 is a schematic cross-sectional view of FIG. 27 taken along section F-F, and FIG. 29 is a partially enlarged schematic diagram of a magnetic attraction member in FIG. 28. In particular, the magnetic attraction member 100E in this embodiment includes a magnetic attraction portion 110E, a base portion 120E and a cam portion 130E, where the magnetic attraction portion 110E is buried or embedded in the base portion 120E, and the cam portion 130E is connected onto one end of the base portion 120E. Preferably, the magnetic attraction member 100E further includes a supporting portion 140E, where the supporting portion 140E is of, for example, a slip-stopping structure with relatively high friction, and is disposed on the base portion 120E and covers the magnetic attraction portion 110E. With such a configuration, the probability that the electronic device 3 slides relative to the magnetic attraction member 100E when being magnetically connected to the magnetic attraction member 100E can be reduced.

Furthermore, the cam portion 130E includes at least one cam surface and an abutting surface. In this embodiment, the cam portion 130E including a first cam surface 132E, a second cam surface 134E, and an abutting surface 136E, and the abutting surface 136E being disposed between the first cam surface 132E and the second cam surface 134E are taken as an example, but the present disclosure is not limited to this. According to the actual required rotational interference stroke, it is also possible to choose to dispose the cam surface only on one side of the abutting surface 136E. Specifically, both the first cam surface 132E and the second cam surface 134E have a varying curvature, while the abutting surface 136E is, for example, a flat surface, and the cam portion 130E is formed with a pivoting hole 138E. With such a configuration, when the magnetic attraction member 100E is pivoted to the fixing base 300E through the cam portion 130E and the pivoting member 600E, the degree of close-fitting interference between the magnetic attraction member 100E and the fixing base 300E will be changed according to the pivoting phase of the cam portion 130E.

In another aspect, the fixing base 300E may include a main body 310E and two lugs 320E, where the main body 310E may include an abutting wall 312E, the lugs 320E are located at two sides of the main body 310E, respectively, and the cam portion 130E abuts against the abutting wall 312E and is located between the two lugs 320E. In some possible embodiments, the magnetic connecting attachment 1E for an electronic device may further include a friction fastener, where the friction fastener is, for example, a consumable with high friction and is detachably disposed on the abutting wall 312E and abuts against the cam portion 130E. In this way, when the cam portion 130E pivots to different phases relative to the abutting wall 312E, the friction fastener can strengthen the interference between the magnetic attraction member 100E and the fixing base 300E, and a user can also replace the friction fastener after the wear of the friction fastener causes the close-fitting ability of the magnetic attraction member and the fixing base to decrease, thus maintaining the fixing ability of the magnetic connecting attachment 1E for an electronic device.

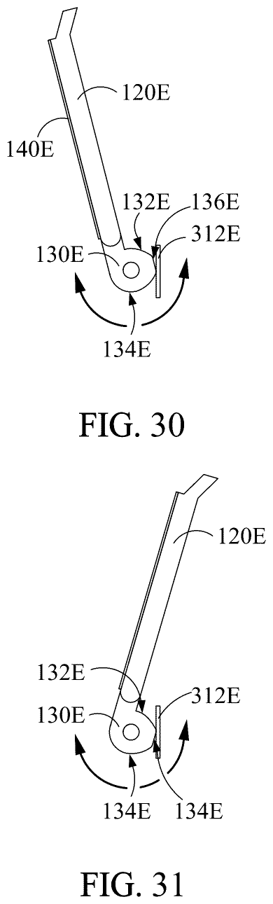

Referring to FIG. 30 and FIG. 31, FIG. 30 is a schematic front view showing that a magnetic attraction member and an abutting wall in FIG. 28 are located at a first use position, and FIG. 31 is a schematic front view showing that a magnetic attraction member and an abutting wall in FIG. 28 are located at a second use position. In a process that the cam portion 130E abuts against the abutting wall 312E with the first cam surface 132E, the abutting surface 136E, and the second cam surface 134E respectively, the cam portion 130E will continuously maintain interference fit with the abutting wall 312E. Specifically, when the cam portion 130E faces the abutting wall 312E with the first cam surface 132E or the second cam surface 134E, since the curvatures of the first cam surface 132E and the second cam surface 134E are relatively large, the magnetic attraction member 100E can pivot relatively freely relative to the fixing base 300E, which is advantageous for the user to lift the fixing target 2 through the lifting member 500E at any angle. On the contrary, when the cam portion 130E abuts against the abutting wall 312E with the abutting surface 136E, since the center distance between the pivoting hole 138E and the abutting surface 136E is relatively large and the curvature of the abutting surface 136E is relatively small, friction interference will be formed between the abutting surface 136E and the abutting wall 312E, so that the magnetic attraction member 100E is maintained at a fixed position relative to the fixing base 300E, further ensuring that the electronic device 3 can be firmly fixed onto the fixing target 2 by magnetic attraction.

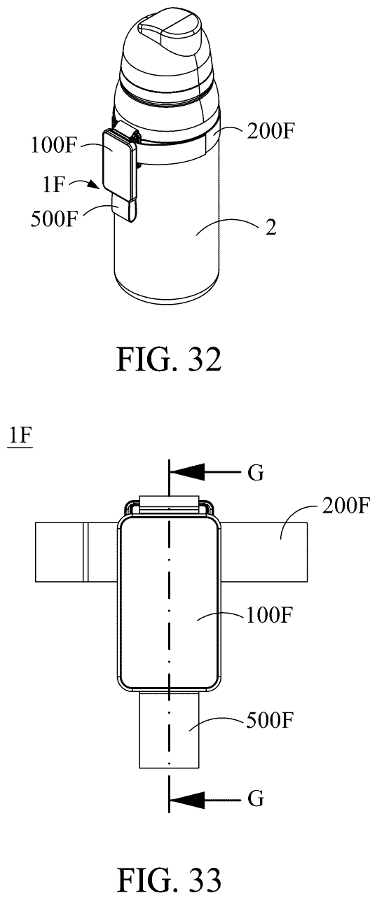

Referring to FIG. 32 and FIG. 33, FIG. 32 is a three-dimensional schematic diagram showing a synergistic effect between a sixth embodiment of a magnetic connecting attachment for an electronic device of the present disclosure and a fixing target, and FIG. 33 is a schematic left side view of a magnetic connecting attachment for an electronic device in FIG. 32. The magnetic connecting attachment 1F for an electronic device in this embodiment includes a magnetic attraction member 100F, a sleeving member 200F, a fixing base 300F and a lifting member 500F. The main difference from the magnetic connecting attachment for an electronic device in the above-mentioned embodiment is that the fixing base 300F of the magnetic connecting attachment 1F for an electronic device includes an engaging portion 320F, and the magnetic attraction member 100F and the engaging portion 310F are selectively engaged with each other.

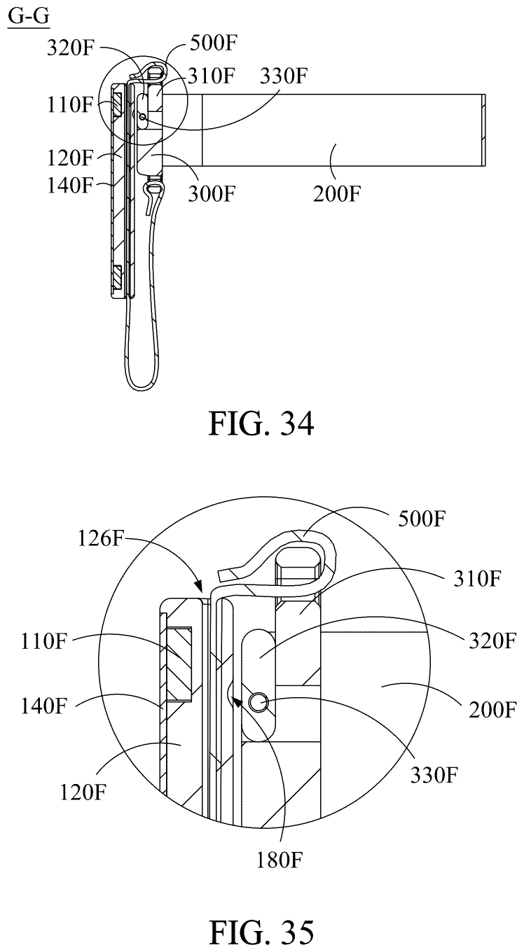

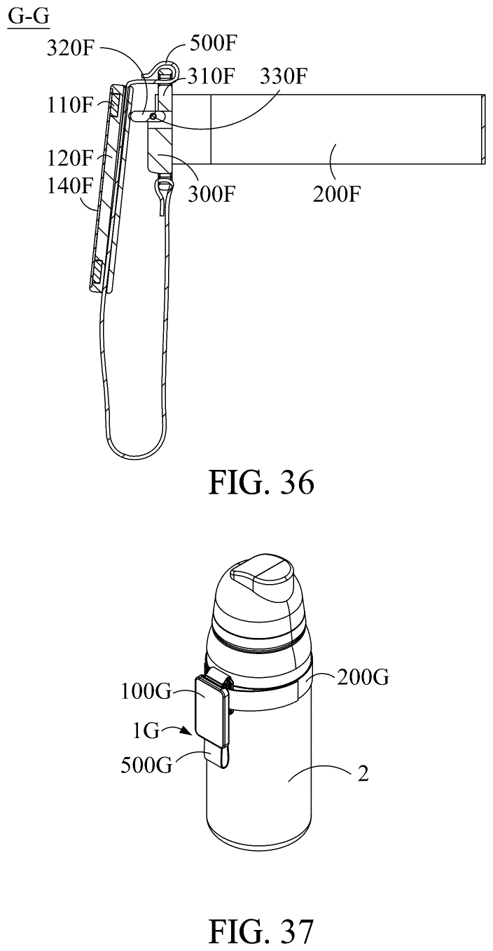

Referring to FIG. 34 to FIG. 36, FIG. 34 is a schematic cross-sectional view of a magnetic connecting attachment for an electronic device of FIG. 33 taken along section G-G in a first mode of use, FIG. 35 is an enlarged schematic diagram of a circular region in FIG. 34, and FIG. 36 is a schematic cross-sectional view of a magnetic connecting attachment for an electronic device of FIG. 33 taken along section G-G in a second mode of use. In particular, the magnetic attraction member 100F in this embodiment includes a magnetic attraction portion 110F, a base portion 120F and a supporting portion 140F, where the magnetic attraction portion 110F is buried or embedded in the base portion 120F, and the supporting portion 140F is disposed on the base portion 120F and covers the magnetic attraction portion 110F. Preferably, a penetrating portion 126F is formed on the base portion 120F, and an engaging slot 180F is formed on the other side of the base portion 120F relative to the supporting portion 140F. In other words, the supporting portion 140F and the engaging slot 180F are disposed on two opposite sides of the base portion 120F. In this embodiment, the penetrating portion 126F is, for example, a long groove penetrating through the base portion 120F, and the engaging slot 180F is, for example, a groove.

In another aspect, the fixing base 300F may include a main body 310F, an engaging portion 320F and an engaging portion pivoting member 330F, where the engaging portion 320F is of, for example, a cantilever structure, and the engaging portion pivoting member 330F is, for example, a positioning pin, and the engaging portion 320F is pivoted to the main body 310F through the engaging portion pivoting member 330F. In addition, one end of the lifting member 500F is connected to the upper end of the fixing base 300F, and the other end of the lifting member 500F penetrates through the penetrating portion 126F, and thereby, the lifting member is connected to the lower end of the fixing base 300F. With such a configuration, when the magnetic connecting attachment 1F for an electronic device is in the first mode of use as shown in FIG. 34, a user can lift the fixing target 2 from the upper end of the fixing base 300F through the lifting member 500F and the sleeving member 200F, and since the magnetic attraction member 100F is not interfered by any element, the magnetic attraction member 100F and the fixing target 2 can freely deflect to a first position relative to the lifting member 500F.

When the user wants to fix the electronic device 3 onto the fixing target 2 by magnetic attraction through the magnetic connecting attachment 1F for an electronic device, the engaging portion 320F can be pivoted to a horizontal state as shown in FIG. 36 and protrude relative to the main body 310F, so that the engaging portion 320F and the engaging slot 180F are engaged with each other. In this way, as shown in FIG. 36, under the gravity of the magnetic attraction member 100F and the electronic device 3 (not shown), the engaging slot 180F will be pressed against the engaging portion 320F, so that the magnetic attraction member 100F is limited by the engaging portion 320F and maintained at a second position of an inclined posture, thus achieving the effect of substantially adjusting the use or viewing angle of the electronic device 3 in a magnetic attraction state.

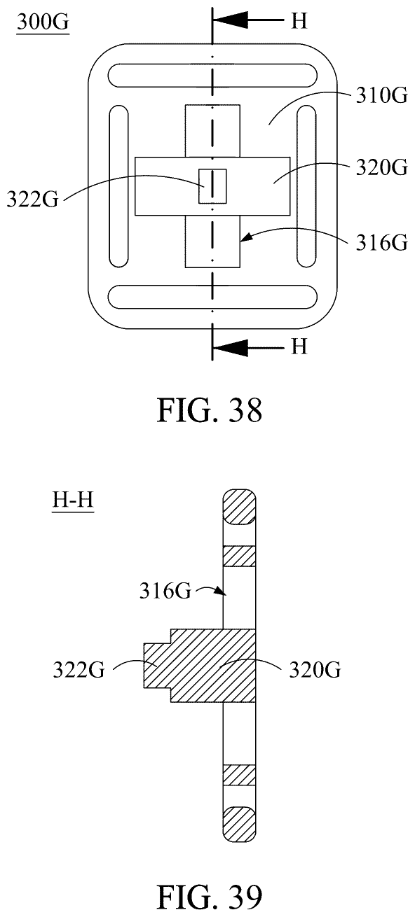

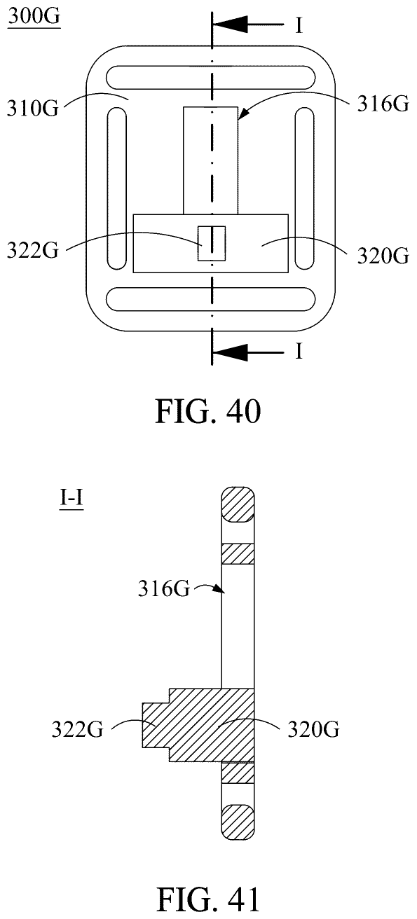

Referring to FIG. 37 to FIG. 41, FIG. 37 is a three-dimensional schematic diagram showing a synergistic effect between a seventh embodiment of a magnetic connecting attachment for an electronic device of the present disclosure and a fixing target, FIG. 38 is a schematic left side view of a fixing base in FIG. 37 at a first use position, FIG. 39 is a schematic cross-sectional view of FIG. 38 taken along section H-H, FIG. 40 is a schematic left side view of a fixing base in FIG. 37 at a second use position, and FIG. 41 is a schematic cross-sectional view of FIG. 40 taken along section I-I. The magnetic connecting attachment 1G for an electronic device in this embodiment is roughly similar to the magnetic connecting attachment 1F for an electronic device in the sixth embodiment, and includes a magnetic attraction member 100G, a sleeving member 200G, a fixing base 300G and a lifting member 500G. The main difference therebetween is that the engaging portion 320G of the magnetic connecting attachment 1G for an electronic device is slidably arranged in the main body 310G.

As shown in FIG. 38 and FIG. 39, the fixing base 300G in this embodiment includes a main body 310G and an engaging portion 320G, where the main body 310G is formed with a slide groove 316G, and the engaging portion 320G is slidably arranged in the slide groove 316G and includes an engaging end 322G. With such a configuration, the engaging portion 320G can be located at a first position in the center of the slide groove 316G as shown in FIG. 37 and FIG. 38, or at a second position at the bottom of the slide groove 316G as shown in FIG. 39 and FIG. 40. Preferably, there is a high friction coefficient between the side wall of the slide groove 316G and the engaging portion 320G, so that the engaging portion 320G can keep a nearly fixed state when sliding to any position on the slide groove 316G. However, in other possible embodiments, a specific position where the engaging portion 320G can slide on the slide groove 316G can be preset by way of a positioning member or a segment gap, which is not limited by the present disclosure.

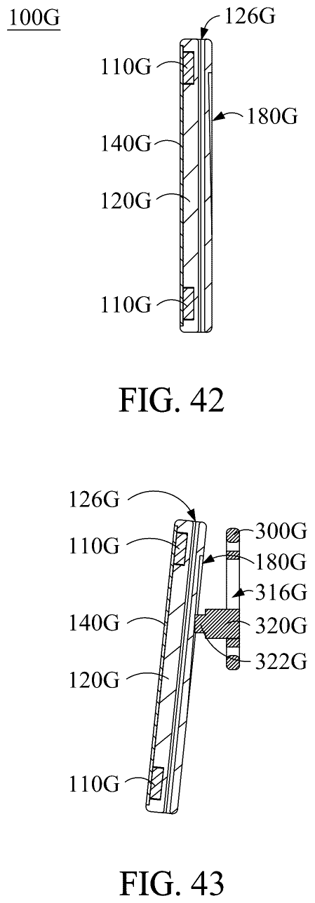

Referring to FIG. 42, FIG. 42 is a schematic side cross-sectional view of a magnetic attraction member in FIG. 37. Similar to the magnetic attraction member 100F, the magnetic attraction member 100G in this embodiment includes a magnetic attraction portion 110G, a base portion 120G, and a supporting portion 140G, where the base portion 120G is formed with a penetrating portion 126G, and an engaging slot 180G is formed on the side, opposite to the supporting portion 140G, of the base portion 120G. In other words, the supporting portion 140G and the engaging slot 180G are disposed on two opposite sides of the base portion 120G. The main difference from the magnetic attraction member 100F is that the engaging slot 180G extends in the extension direction of the base portion 120G, and the slot depth of the engaging slot 180G gradually changes.

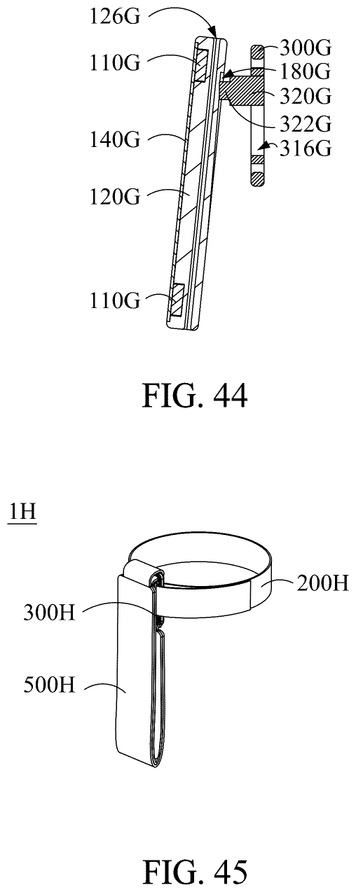

Referring to FIG. 43 and FIG. 44, FIG. 43 is a schematic cross-sectional view of a magnetic attraction member and a fixing base in FIG. 37 in a first mode of use, and FIG. 44 is a schematic cross-sectional view of a magnetic attraction member and a fixing base in FIG. 37 in a second mode of use. When a user moves the engaging portion 320G to a first position as shown in FIG. 43, the engaging end 322G is engaged at a specific position of the engaging slot 180G, and in this embodiment, taking the engaging end 322G corresponding to the shallow slot depth of the engaging slot 180G at this time as an example, the interference between the magnetic attraction member 100G and the fixing base 300G is relatively small. When the user moves the engaging portion 320G to a second position as shown in FIG. 44, the engaging end 322G will correspond to a deeper slot depth of the engaging slot 180G. At this time, there is great interference between the magnetic attraction member 100G and the fixing base 300G, so that the magnetic attraction member and the fixing base are fixed to each other. Therefore, relatively stable fixing ability can be provided for the electronic device 3 magnetically attracted onto the magnetic attraction member 100G. However, in other possible embodiments, the slot depth of the engaging slot 180G can also be maintained fixed, and the inclination angle of the magnetic attraction member 100G can be changed only by moving the position of the engaging portion 320G, which is not limited by the present disclosure.

It is worth mentioning that the engaging portion of the magnetic connecting attachment 1F for an electronic device in the sixth embodiment and the magnetic connecting attachment 1G for an electronic device in the seventh embodiment can be combined with each other, that is, the engaging portions can slide relative to the main body at the same time, and when sliding to a specific position, the engaging portions can also pivot and protrude relative to the main body again. In this way, when the engaging portion does not pivot and protrude, the magnetic attraction member can be provided with greater degree of freedom of pivoting, and the engaging position between the engaging portion and the magnetic attraction member obtains greater elasticity.

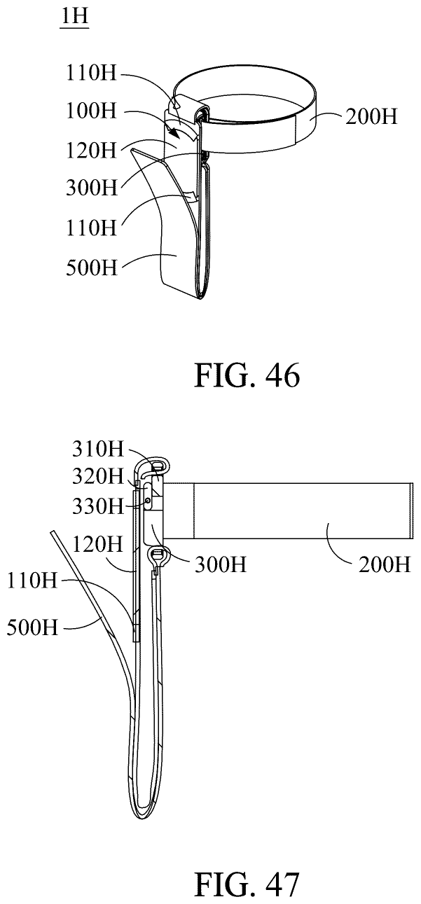

Referring to FIG. 45 to FIG. 47, FIG. 45 is a three-dimensional schematic diagram of an eighth embodiment of a magnetic connecting attachment for an electronic device of the present disclosure, FIG. 46 is a three-dimensional schematic diagram of some elements unfolded in FIG. 45, and FIG. 47 is a schematic side cross-sectional view of FIG. 46. The magnetic connecting attachment 1H for an electronic device in this embodiment is roughly similar to the magnetic connecting attachment 1F for an electronic device in the sixth embodiment, and includes a magnetic attraction member 100H, a sleeving member 200H, a fixing base 300H and a lifting member 500H. The main difference therebetween is that the magnetic attraction member 100H of the magnetic connecting attachment 1H for an electronic device is buried in the lifting member 500h.

As shown in FIG. 45, the magnetic attraction member 100H includes a magnetic attraction portion 110H and a base portion 120H, where the magnetic attraction portion 110H is, for example, an arc-shaped magnet corresponding to the magnetic feature of the electronic device 3, and the base portion 120H presents a disk shape, and grooves for fitting the magnetic attraction portion 110H are formed in upper and lower ends. In addition, the lifting member 500H is formed of, for example, relatively thick woven fabric or leather with high friction, and the magnetic attraction member 100H is buried in the lifting member 500H. Specifically, the lifting member 500H can be formed by laminating a plurality of layers of woven fabric or leather, with adhesiveness between layers, and the magnetic attraction member 100H is wrapped therein by way of attaching the layers to each other. With such a configuration, not only is there no need to occupy a specific shape outside the lifting member 500H, but also the position or pattern of the magnetic attraction member 100H can be freely adjusted as needed, thus greatly improving the elasticity in use of the magnetic connecting attachment 1H for an electronic device.

In another aspect, the fixing base 300H includes a main body 310H, an engaging portion 320H and an engaging portion pivoting member 330H, and the engaging portion 320H is pivoted to the main body 310H through the engaging portion pivoting member 330H. In this way, when a user wants to fix the electronic device 3 onto the fixing target 2 through the magnetic attraction member 100H, the engaging portion 320H can pivot and protrude relative to the main body 310H, and is engaged with the magnetic attraction member 100H buried in the lifting member 500H, thereby improving the stability of the electronic device 3 when it is magnetically attracted.

The present disclosure has been disclosed in the preferred embodiments above, but those skilled in the art should understand that the foregoing embodiments are only used to describe the present disclosure and should not be interpreted as limiting the scope of the present disclosure. It should be noted that all changes and substitutions equivalent to the above-mentioned embodiments should be regarded as included in the scope of the present disclosure, and the technical features of the foregoing embodiments can be combined, substituted, omitted and changed as appropriate without conceptual contradictions or structural conflicts. Therefore, the scope of protection of the present disclosure shall be subject to the definition of the scope of the patent application.

What is claimed is:

1. A magnetic connecting attachment for an electronic device, adapted for an electronic
device and a fixing target, the magnetic connecting attachment for an electronic device comprising:
a magnetic attraction member, selectively magnetically connected to the electronic device;
a sleeving member, detachably sleeved on the fixing target and adapted to be tightened and attached on a surface of the fixing target; and
a fixing base, disposed on the sleeving member and connected to the magnetic attraction member, wherein the magnetic attraction member is adapted to be fixed at a first position or a second position relative to the fixing base.

2. The magnetic connecting attachment for an electronic device according to claim 1,
wherein the sleeving member comprises:
a ring portion, defining a fixing channel, the fixing target being adapted to penetrate through the fixing channel; and
an end portion, connected to the ring portion,
wherein the fixing base is formed with a through hole, the end portion penetrates through the through hole, and the fixing base is adapted to move relative to the end portion to change a size of the fixing channel.

3. The magnetic connecting attachment for an electronic device according to claim 2,
wherein the fixing base comprises:
a main body, wherein the through hole is formed in the main body;
an adjusting member, disposed on the main body and protruding relative to the main body;
a clamping member, disposed on the main body and selectively protruding towards an interior of the through hole; and
an elastic member, disposed between the adjusting member and the clamping member.

4. The magnetic connecting attachment for an electronic device according to claim 2, wherein the magnetic attraction member is connected to the end portion, and the magnetic attraction member and the ring portion are disposed on two different sides of the fixing base.

5. The magnetic connecting attachment for an electronic device according to claim 1, wherein the electronic device comprises a magnetic feature, and the magnetic attraction member comprises a magnetic attraction portion and an adjusting portion, a shape of the magnetic attraction portion corresponding to at least a part of the magnetic feature and being adapted to be magnetically connected to the magnetic feature, and the adjusting portion being connected between the magnetic attraction portion and the fixing base and having flexibility.

6. The magnetic connecting attachment for an electronic device according to claim 5, wherein the magnetic attraction portion is of an arc-shaped structure, and a central angle included in the arc-shaped structure ranges from 60 degrees to 120 degrees.

7. The magnetic connecting attachment for an electronic device according to claim 1, further
comprising:
an engaging member, pivotally connected to the magnetic attraction member,
wherein the fixing base comprises an engaging portion, and the engaging member and the engaging portion are selectively engaged with each other.

8. The magnetic connecting attachment for an electronic device according to claim 7, wherein one of the engaging member and the engaging portion is formed with a fitting groove, and the other of the engaging member and the engaging portion is selectively fitted in the fitting groove.

9. The magnetic connecting attachment for an electronic device according to claim 8, wherein one of the engaging member and the engaging portion comprises a bottom wall, the bottom wall surrounding at least a part of the fitting groove, and the other of the engaging member and the engaging portion comprises an abutting surface, and when the abutting surface abuts against the bottom wall, the engaging member and the engaging portion are fixed to each other.

10. The magnetic connecting attachment for an electronic device according to claim 7, wherein the engaging member is adapted to be engaged with the engaging portion to each other in two different directions of the engaging portion.

11. The magnetic connecting attachment for an electronic device according to claim 7, further comprising a magnetic attraction positioning member, wherein the magnetic attraction positioning member is disposed between the magnetic attraction member and the engaging member and selectively fixes the magnetic attraction member relative to the engaging member.

12. The magnetic connecting attachment for an electronic device according to claim 7, further comprising a lifting member, wherein the lifting member is connected to the engaging member, and the lifting member and the engaging member together surround the engaging portion.

13. The magnetic connecting attachment for an electronic device according to claim 7, wherein the fixing base further comprises two side walls, the two side walls protruding relative to the sleeving member, and the engaging portion is disposed between the two side walls.

14. The magnetic connecting attachment for an electronic device according to claim 1, wherein the magnetic attraction member is pivotally connected to the fixing base.

15. The magnetic connecting attachment for an electronic device according to claim 14, further comprising a pivoting member, wherein the pivoting member is disposed between the magnetic attraction member and the fixing base, one of the magnetic attraction member and the fixing base is formed with a slide groove, and the pivoting member is slidably arranged in the slide groove.

16. The magnetic connecting attachment for an electronic device according to claim 15, wherein the slide groove extends in a lifting direction, and one of the magnetic attraction member and the fixing base has a first groove wall and a second groove wall; the first groove wall and the second groove wall surround at least a part of the slide groove and are disposed on two opposite sides of the slide groove in the lifting direction; the pivoting member selectively abuts against the first groove wall or the second groove wall, and a friction coefficient between the first groove wall and the pivoting member is different from that between the second groove wall and the pivoting member.

17. The magnetic connecting attachment for an electronic device according to claim 14, further comprising a pivoting member, wherein the fixing base comprises a stopping portion, the magnetic attraction member pivots relative to the fixing base through the pivoting member and comprises a cam surface, and the cam surface and the stopping portion abut against each other.

18. The magnetic connecting attachment for an electronic device according to claim 14,
further comprising:
a pivoting member, disposed on one end of the magnetic attraction member and penetrating through or being pivoted to the fixing base; and
a lifting member, connected between the other end of the magnetic attraction member and the fixing base.

19. The magnetic connecting attachment for an electronic device according to claim 18,
wherein the fixing base is formed with a latching groove, and the lifting member comprises:
a connecting portion, penetrating through the latching groove and having flexibility, and one end of the connecting portion is disposed on the magnetic attraction member; and
a latching portion, disposed on the other end of the connecting portion, and a dimension of the latching portion is greater than that of the latching groove.

20. The magnetic connecting attachment for an electronic device according to claim 1, wherein the fixing base is pivoted to the sleeving member.

21. The magnetic connecting attachment for an electronic device according to claim 20, further comprising a fixing base positioning member, wherein the fixing base positioning member is disposed between the fixing base and the sleeving member and selectively fixes the fixing base relative to the sleeving member.

22. The magnetic connecting attachment for an electronic device according to claim 1,
wherein the magnetic attraction member comprises:
a base portion, adapted to support the electronic device; and
a cam portion, connected to the base portion and comprising at least one cam surface and an abutting surface,
wherein the fixing base comprises an abutting wall, and the cam portion abuts against the abutting wall.

23. The magnetic connecting attachment for an electronic device according to claim 22, wherein a number of the at least one cam surface is two, and the abutting surface is disposed between the two cam surfaces.

24. The magnetic connecting attachment for an electronic device according to claim 22, further comprising a friction fastener, wherein the friction fastener is detachably disposed on the abutting wall and abuts against the cam portion.

25. The magnetic connecting attachment for an electronic device according to claim 1, wherein the fixing base comprises a main body and an engaging portion, the engaging portion being adapted to protrude from the main body and abutting against the magnetic attraction member.

26. The magnetic connecting attachment for an electronic device according to claim 25, wherein an engaging slot is formed in the magnetic attraction member, and the engaging slot is adapted to abut against the engaging portion.

27. The magnetic connecting attachment for an electronic device according to claim 1, further comprising a lifting member, wherein two ends of the lifting member are connected to the fixing base to form a lifting channel, and the magnetic attraction member is disposed on the lifting member.

28. The magnetic connecting attachment for an electronic device according to claim 27, wherein the magnetic attraction member is buried in the lifting member.

29. The magnetic connecting attachment for an electronic device according to claim 1, wherein the sleeving member comprises a belt body and an adhesive-fastening feature, the belt body being adapted to define a fixing channel, the adhesive-fastening feature being disposed on one part of the belt body, and the other part of the belt body being adapted to be adhesive-fastened at different positions of the adhesive-fastening feature to adjust a size of the fixing channel.

30. The magnetic connecting attachment for an electronic device according to claim 1, wherein a non-slip feature is formed on the surface of the above-mentioned sleeving member, which is adapted to be sleeved onto the fixing target.
